(19) United States
(12) Patent Application Publication
(10) Pub. No.: US 2019/0144328 A1
(43) Pub. Date: May 16, 2019

(54) SODA-LIME-SILICA GLASS COMPOSITION

(71) Applicant: VERALLIA FRANCE, Courbevoie (FR)

(72) Inventor: Simone FERRARO, CAIRO MONTENOTTE (IT)

(73) Assignee: VERALLIA FRANCE, Courbevoie (FR)

(21) Appl. No.: 16/098,357

(22) PCT Filed: May 3, 2017
(86) PCT No.: PCT/FR2017/051052

§ 371 Date: Nov. 1, 2018

(30) Foreign Application Priority Data
May 4, 2016 (FR) 1654043

(51) Int. Cl. C03C 3/087; C03C 4/02; C03C 4/08

(52) U.S. Cl. CPC C03C 3/087; C03C 2204/00; C03C 4/085; C03C 4/02

(57) ABSTRACT

A soda-lime-silica glass composition, includes the optical absorbers below in contents varying within the following weight limits: Fe₂O₃ (total iron) 100 to 1600 ppm, Cr₂O₃ 20 to 100 ppm, S²⁻ 10 to 50 ppm. The composition has a redox, defined by the molar ratio between the ferrous iron and the total iron, of less than 0.7.

The present invention relates to a soda-lime-silica glass composition intended for the production of articles, in particular made of hollow glass, such as bottles, flasks or pots, having a high light transmission and a golden color.

Besides the bottles made of clear glass that by nature have a high light transmission, the shades of the bottles offered to the agri-food industry, in particular in the wine sector, vary within green, amber or else brown-red tones. The amber shades are generally obtained by adding sulfur and iron oxide to a reduced glass. The iron sulfides thus formed give the glass a yellow-amber shade due to a very intense absorption for wavelengths located around 400 nm. These shades generally have a relatively low light transmission.

The choice of the shade of a bottle is linked in particular to marketing considerations. The agri-food industry therefore remains eager for new shades that enhance the containers. Within this context, the present invention proposes a glass composition having a golden shade and also a light transmission of greater than 50% while retaining a high screening power in order to prevent the impairment of the organoleptic properties of the contents, in particular by ultraviolet radiation.

Cullet is the main raw material for the manufacture of glass packagings. Each bottle contains on average 60% of recycled glass, these proportions being driven to increase with the development of recycling networks. A golden shade combined with a high light transmission and a high filtering power is difficult to obtain considering the constraints related to the manufacture of glass packagings. Specifically, the presence of certain coloring elements in the cullet, in addition to those present in the impurities of the natural raw materials, has the effect of reducing the light transmission of the glasses obtained. It is then necessary to use white or even extra-white cullets, containing few coloring elements in order to achieve the desired light transmission levels. However, the use of these cullets poses a problem of availability and increases the production cost. The present invention makes it possible, on the contrary, to limit the use of white or extra-white cullets.

Thus, the present invention relates to a soda-lime-silica glass composition, comprising the optical absorbers below in contents varying within the following weight limits:

| | |
|---|---|
| F₂O₃ (total iron) | 100 to 1600 ppm, |
| Cr₂O₃ | 20 to 100 ppm, |
| S²⁻ | 10 to 50 ppm, |

said composition having a redox, defined by the molar ratio between the ferrous iron and the total iron, of less than 0.70, preferably less than 0.68, more preferentially less than 0.67, or even less than 0.66.

Cr₂O₃ respectively represents the total content of chromium in the glass, expressed respectively as chromium trioxide. S²⁻ represents the amount of sulfur present in the glass in the form of sulfide ions.

The use of the aforementioned optical absorbers within the limits of the invention makes it possible to impart the desired properties to the glass. The action of the absorbers taken individually is in general well described in the literature.

The presence of iron in a glass composition may result from the raw materials, as impurities, or from a deliberate addition that aims to color the glass. It is known that iron exists in the structure of the glass in the form of ferric (Fe³⁺) ions and ferrous (Fe²⁺) ions. The presence of Fe³⁺ ions imparts a slight yellow coloration to the glass and makes it possible to absorb the ultraviolet radiation. The presence of Fe²⁺ ions gives the glass a stronger blue-green coloration and leads to absorption of the infrared radiation. The increase in the content of iron in its two forms intensifies the absorption of the radiation at the ends of the visible spectrum, this effect taking place to the detriment of the light transmission.

In the present invention, the content of total iron in the composition is between 100 and 1600 ppm, preferably greater than or equal to 500 ppm, or even 800 ppm and/or less than or equal to 1500 ppm, or even 1400 ppm. An iron content of less than 100 ppm necessitates resorting to raw materials that have a high degree of purity which results in a cost of the glass which is much too high for use as a bottle or flask.

Sulfur is present in the glass either intentionally, added as glass colorant or refining agent (it helps to eliminate gaseous inclusions), or simply present in certain raw materials. Sulfur exists in the glass in two oxidation states: SO₄²⁻ sulfate ions and, under reducing conditions, S²⁻ sulfide ions. The latter, when they are present in connection with Fe³⁺ ferric ions give rise to an extremely intense yellow-amber coloration resulting from an electron transfer between the two ions. Within the context the present invention, contents of sulfide ions of less than 10 ppm do not make it possible to obtain the desired golden shade. Contents of greater than 50 ppm on the contrary impart stronger shades that reduce the light transmission of the glass. The most satisfactory results are obtained with contents preferably of less than or equal to 40 ppm, and/or greater than or equal to 20 ppm.

Chromium is present in the glasses according to the invention in the form of Cr³⁺ ions, which impart a green coloration. The content, expressed as Cr₂O₃, is advantageously as low as possible in order to retain sufficient light transmission, while remaining greater than or equal to 20 ppm. The redox conditions of the glass according to the invention make it possible however to accept chromium contents up to 100 ppm, preferably less than 80 ppm, or even less than 50 ppm, for example between 20 and 40 ppm. It is thus possible to use raw materials, in particular half-white cullets, of lower purity that are more abundant and therefore more advantageous from the economic point of view.

As a general rule, it is difficult to predict the optical and energy properties of a glass when this glass contains several optical absorbers. This is because these properties result from a complex interaction between the various absorbers, the behavior of which is additionally a link to the glass matrix used and to their oxidation state.

In the present invention, the choice of the optical absorbers, of their content and of their redox state is decisive for obtaining the required optical properties.

The redox, defined by the ratio of the molar content between the ferrous iron and the total iron, which is an indicator of the redox state of the glass, must be less than 0.70 in order to obtain the desired golden shade. It is preferably less than 0.68, or less than 0.67, or even less than 0.66, while preferably remaining greater than 0.50, or greater than 0.60. This redox range has proved suitable for forming the desired coloring species.

The redox is generally controlled with the aid of oxidizing agents such as sodium sulfate, and reducing agents such as coke, the relative contents of which are adjusted in order to obtain the desired redox. The reduced forms of sulfur may also act as a reducing agent with respect to the iron oxides, which makes the prediction of the optical properties of a glass resulting from a given mixture particularly complex, or even impossible.

The glass compositions in accordance with the invention are such that the glass preferably has a dominant wavelength between 574 and 578 nm, preferably between 575.5 and 577 nm, a purity of from 45% to 70%, and a light transmission factor of greater than 50%, in particular of from 50% to 65%. These parameters are calculated for a thickness of 5 mm from an experimental spectrum of glass samples, taking as reference the standard illuminant C and the “CIE 1931” reference observer, both defined by the C.I.E. (Commission Internationale de l'Eclairage or International Commission on Illumination). The compositions of glasses according to the invention also have a screening power, for a thickness of 5 mm, of greater than or equal to 80%, in particular greater than or equal to 85% and/or less than 95%, said screening power being defined as being equal to the value of 100% minus the arithmetic mean of the transmission between 330 and 450 nm.

Within the context of the present invention, one particular preferred composition comprises the following optical absorbers in contents varying within the following weight limits:

| | |
|---|---|
| Fe₂O₃ (total iron) | 500 to 1400 ppm, |
| Cr₂O₃ | 20 to 80 ppm, preferably 20 to 40 ppm, |
| S²⁻ | 20 to 40 ppm. |

The expression “soda-lime-silica” is used here in the broad sense and relates to any glass composition composed of a glass matrix which comprises the following constituents (in percentages by weight).

| | |
|---|---|
| SiO₂ | 64-75% |
| Al₂O₃ | 0-5% |
| B₂O₃ | 0-5% |
| CaO | 5-15% |
| MgO | 0-10% |
| Na₂O | 10-18% |
| K₂O | 0-5% |
| BaO | 0-5% |

It is acknowledged here that the soda-lime-silica glass composition may comprise, besides the inevitable impurities contained in particular in the raw materials, a small proportion (up to 1%) of other constituents, for example agents for promoting the melting or refining of the glass (SO₃, Cl, Sb₂O₃, As₂O₃) or that come from a possible addition of recycled cullet into the batch mix.

In the glasses according to the invention, the silica is generally kept within narrow limits for the following reasons: above 75%, the viscosity of the glass and its ability to devitrify increase greatly, which makes it more difficult to melt and flow on the molten tin bath. Below 64%, the hydrolytic resistance of the glass decreases rapidly and the transmission in the visible range also decreases.

Alumina Al₂O₃ plays a particularly important role in the hydrolytic resistance of the glass. When the glass according to the invention is intended to form hollow bodies that contain liquids, the content of alumina is preferably greater than or equal to 1%.

The alkali metal oxides Na₂O and K₂O facilitate the melting of the glass and make it possible to adjust its viscosity at high temperatures in order to keep it close to that of a standard glass. K₂O may be used up to 5% since beyond this the problem of the high cost of the composition arises. Furthermore, the increase in the percentage of K₂O can be accomplished, for the main part, only to the detriment of Na₂O, which contributes to increasing the viscosity. The sum of the Na₂O and K₂O contents, expressed as weight percentages, is preferably equal to or greater than 10% and advantageously less than 20%. If the sum of these contents is greater than 20% or if the content of Na₂O is greater than 18%, the hydrolytic resistance is greatly reduced. The glasses according to the invention are preferably free of lithium oxide Li₂O due to its high cost.

The alkaline-earth metal oxides make it possible to adapt the viscosity of the glass to the production conditions.

MgO may be used up to around 10% and its omission may be at least partly compensated for by an increase in the content of Na₂O and/or SiO₂. Preferably, the content of MgO is less than 5% and particularly advantageously is less than 2% which has the effect of increasing the infrared absorptivity without impairing the transmission in the visible range. Low contents of MgO additionally make it possible to reduce the number of raw materials needed for melting the glass.

BaO has a much smaller influence than CaO and MgO on the viscosity of the glass and the increase in its content is mainly accomplished to the detriment of the alkali metal oxides, MgO and especially CaO. Any increase in BaO contributes to increasing the viscosity of the glass at low temperatures. Preferably, the glasses according to the invention are free of BaO and also of strontium oxide (SrO), these elements having a high cost.

Apart from complying with the limits defined previously for the variation in the content of each alkaline-earth metal oxide, it is preferable, in order to obtain the desired transmission properties, to limit the sum of the weight percentages of MgO, CaO and BaO to a value equal to or less than 15%.

The composition according to the invention does not in general comprise other absorbers or other colorants (in particular CoO, MoO₃, CeO₂, V₂O₃, or MnO), with the exception of inevitable impurities. Particularly preferably, the glasses according to the invention do not contain rare-earth oxides and in particular no neodymium oxide or cerium oxide, which are extremely expensive. Advantageously, the glass according to the invention is free of coloring particles based on CdS and/or CdSe due to their high toxicity.

The glass composition in accordance with the invention is capable of being melted under conditions for producing glass intended for forming hollow bodies by the techniques of pressing, blowing and molding. The melting generally takes place in flame-fired furnaces, optionally provided with electrodes for heating the glass in the bulk, by passing an electric current between the two electrodes. To facilitate the melting, and in particular to make the latter mechanically advantageous, the glass composition advantageously has a temperature corresponding to a viscosity η such that log η=2 which is below 1500° C. More preferably, the temperature corresponding to the viscosity such that log η=3.5 (denoted T(log η=3.5)) and the liquidus temperature (denoted T_{liq}) satisfy the relationship:

T(log η=3.5)−T_{liq}>20° C.

and better still:

T(log η=3.5)−T_{liq}>50° C.

The glass composition according to the invention is conventionally obtained by melting a batch mix in a furnace. The glass according to the invention does not in general require the addition of absorbers other than those contained in the raw materials. This is because the amounts of iron oxide and chromium oxide necessary for the composition according to the invention are provided in particular by the cullets.

Another subject of the present invention thus relates to a process for manufacturing a glass having a composition according to the invention, comprising a step of melting the batch mix in a melting furnace, said batch mix providing all of the oxides included in said composition, and a step of forming said glass in order to obtain a hollow article.

Another subject of the invention is the hollow glass article formed by molding, pressing or blowing having a chemical composition and optical properties as defined above.

The present invention will be better understood on reading the detailed description below of nonlimiting exemplary embodiments below.

The following glass composition according to the invention was prepared from a batch mix comprising 25% by weight of half-white cullet, the contents being expressed as weight percentages:

| | |
|---|---|
| SiO₂ | 73.6% |
| Na₂O | 12.4% |
| K₂O | 0.8% |
| CaO | 10.3% |
| MgO | 1.1% |
| Al₂O₃ | 0.35% |
| Fe₂O₃ (total) | 1430 ppm |
| Cr₂O₃ | 30 ppm |
| S²⁻ | 36 ppm |
| Redox | 0.65 |

The weight contents of iron oxides and chromium oxides and also of sulfide ions are measured by chemical analysis.

The redox is defined as being the molar ratio of FeO to total iron expressed in the form of Fe₂O₃. The total iron content is measured by x-ray fluorescence and the FeO content is measured by wet chemistry.

The values of the following optical properties were calculated for a glass thickness of 5 mm from experimental spectra:
the light transmission factor, calculated between 380 and 780 mm, and also the dominant wavelength and the purity. These calculations are made using the illuminant C as defined by the ISO/CIE 10526 standard and the C.I.E. 1931 colorimetric reference observer, as defined by the ISO/CIE 10527 standard.
the screening power defined as being equal to the value of 100% minus the arithmetic mean of the transmission between 330 and 450 nm.

The results are presented below:

| Dominant wavelength | 576 nm |
|---|---|
| Purity | 63% |
| Light transmission factor | 56% |

1. A soda-lime-silica glass composition, comprising the optical absorbers below in contents varying within the following weight limits:

| | |
|---|---|
| Fe₂O₃ (total iron) | 100 to 1600 ppm, |
| Cr₂O₃ | 20 to 100 ppm, |
| S²⁻ | 10 to 50 ppm, |

the composition having a redox, defined by the molar ratio between the ferrous iron and the total iron, of less than 0.7.

2. The composition as claimed in claim 1, such that the content of iron oxide (Fe₂O₃) is between 500 and 1500 ppm.

3. The composition as claimed in claim 1, such that the content of chromium oxide (Cr₂O₃) is indeed between 20 and 80 ppm.

4. The composition as claimed in claim 1, such that the content of sulfide ions (S²⁻) is between 20 and 40 ppm.

5. The composition as claimed in claim 1, such that the redox is less than 0.68.

6. The composition as claimed in claim 1, such that the glass has, for a thickness of 5 mm, a dominant wavelength between 574 and 578 nm, a purity of from 45% to 70%, and a light transmission factor of greater than 50%.

7. The composition as claimed in claim 1, such that the glass has, for a thickness of 5 mm, a screening power of greater than or equal to 80%.

8. A hollow glass article formed by molding, pressing or blowing, such that its chemical composition are defined by claim 1.

9. The composition as claimed in claim 2, such that the content of iron oxide (Fe₂O₃) is between 800 and 1400 ppm.

10. The composition as claimed in claim 5, such that the redox is less than 0.67.

11. The composition as claimed in claim 10, such that the redox is less than 0.66.

12. A hollow glass article formed by molding, pressing or blowing, such that its optical properties are defined by claim 6.

13. A hollow glass article formed by molding, pressing or blowing, such that its optical properties are defined by claim 7.
